(19) United States
(12) Patent Application Publication
(10) Pub. No.: US 2015/0226270 A1
(43) Pub. Date: Aug. 13, 2015

(54) ELECTROMOTIVE DRIVE

(71) Applicant: BÜHLER MOTOR GMBH, Nurnberg (DE)

(72) Inventors: Jürgen Strüber, Nurnberg (DE); Thomas Peterreins, Nurnberg (DE)

(73) Assignee: BÜHLER MOTOR GMBH, Nurnberg (DE)

(21) Appl. No.: 14/613,625

(22) Filed: Feb. 4, 2015

(30) Foreign Application Priority Data
Feb. 7, 2014 (DE) 102014202279.7

(51) Int. Cl. F16C 19/00

(52) U.S. Cl. CPC F16D 3/50; F16D 3/02

(57) ABSTRACT

Electromotive drive used with an electric motor having a rotor with a motor shaft in first and second bearings and a working shaft in third and fourth bearings. The drive includes a shaft coupling for joining the motor and working shafts to ensure transmission of torque and radial force from the motor shaft to the working shaft, centering the motor and working shafts, not transmitting any axial force and compensating for any misalignment of the motor and working shafts; a coupling-contiguous end shield; and a coupling-contiguous ball bearing having an outer ring, wherein the motor shaft is mounted axially by means of the ball bearing, and the outer ring of the ball bearing is not fixed radially to the end shield, so that there is no redundancy despite double mounting of the motor shaft to the first and second bearings and the working shaft to the third and fourth bearings.

### CROSS-REFERENCE TO RELATED APPLICATIONS

The present patent application claims priority from German Application No. DE102014202279.7, filed Feb. 7, 2014, which is incorporated herein by reference in its entirety.

### BACKGROUND OF THE INVENTION

(1) Field of the Invention

The invention relates to an electromotive drive, having an electric motor, along with a stator, and a rotor mounted in two mounts thus defining a motor shaft that by means of a shaft coupling is connected in a torque-proof manner to a working shaft of a machine also mounted in two mounts. The working machine is preferably a pump.

(2) Description of Related Art Including Information Disclosed Under 37 CFR 1.97 and 1.98

For logistical reasons, electric motors and machines assembled on them are frequently manufactured separately, often by different manufacturers. At the same time, for technical reasons it makes sense to execute both electric motors and machines in such a way that in each instance, the motor shaft of the electric motor and the working shaft of the machine are doubly mounted. However, because of tolerances this leads to mechanical inaccuracies at the interface between the electric motor and the machine, in particular at a shaft coupling.

It is therefore a problem of the prior art to ensure compensation for angular errors and errors of concentricity between the motor shaft and the working shaft. In addition, the greatest possible torque in small spaces should be transmissible and little or no rotary play should be present between the motor shaft and the working shaft, in order to prevent objectionable noise and wear and tear when the torque changes. In addition, the number of parts should be minimal and assembly should be easy. The present invention is directed to taking care of these problems.

### SUMMARY OF THE INVENTION

According to the invention, the problems are solved by the provision of a shaft coupling that ensures the transmission of torque and radial force, centers the motor and working shafts to one another, does not transmit any axial force and compensates for any angular errors caused by manufacturing tolerances, wherein only slight tilting is allowed and the motor shaft is axially mounted in the coupling area by means of a coupling-contiguous ball bearing, and the outer ring of the coupling-contiguous ball bearing is radially not fixed to a housing, so that there is no redundancy despite double mounting of motor shaft and output shaft. The coupling-contiguous ball bearing does not act as a radial bearing and can be oriented according to any tolerance-related axle misalignment, which prevents any structural redundancy. In operation, the coupling-contiguous ball bearing acts as a simple axial bearing with regard to spring preload, vibrational forces, etc., but can also be executed as a “normal” radial deep groove ball bearing.

Further developments of the invention provide that a free space is available between the outer ring of the coupling-contiguous ball bearing and a coupling-contiguous end shield in the radial direction. This free space ensures the radial alignment capability of the coupling-contiguous ball bearing based on any tolerance-related axle misalignment that occurs.

This free space between the coupling-contiguous ball bearing and the coupling-contiguous end shield can be designed as an empty space. As a result, no radial force component is exercised on the coupling-contiguous ball bearing during operation. This reduces losses and extends the service life of the bearings. A disadvantage of the empty space is a certain tendency to vibrate at high mechanical loads. In addition, it can lead to assembly problems if the radial orientation of the coupling-contiguous ball bearing is undefined up to a point. In order to minimize this disadvantage, the space in between should be only large enough to allow the tolerance-related axle misalignment to be exactly compensated for.

In order to reduce vibrations and ensure pre-centering, an elastic ring can be arranged in the free space between the coupling-contiguous ball bearing and the coupling-contiguous end shield. This reduces the operating noise and permits a radial displacement of the coupling-contiguous ball bearing in order to compensate for any axle misalignment in the coupling area. The mount in this case, together with the elastic ring, provides sufficient support, so that the electric motor can run in test mode without the machine being attached. However, the elastic ring has the disadvantage that, during operation, it causes a radial force component to act upon the coupling-contiguous ball bearing, which can increase losses and reduce the service life of the ball bearings.

In order to combine the advantages of the empty space with the advantages of the elastic ring and to avoid most of the disadvantages, it is proposed that an attenuator or an impact-attenuating material that is supported by the outer ring of the coupling-contiguous ball bearing is arranged radially around the outer ring of the coupling-contiguous ball bearing. This measure improves the cushioning of vibrations, when the attenuator or impact-attenuating material does not radially touch the coupling-contiguous end shield or does not affect the position of the coupling-contiguous ball bearing in a radial direction. This also prevents radial force components from acting upon the coupling-contiguous ball bearing.

Another advantageous embodiment of the invention provides that the coupling-contiguous ball bearing is held axially free of play between a motor shaft-solid press sleeve and a clamp disk supported on the coupling-contiguous end shield. A backlash-free coupling-contiguous ball bearing can be produced by the press sleeve and the clamp disk. In many applications, as a result of shock load, the maximum acceleration force is greater than a spring preload force. The press sleeve guarantees secure transmission of axial forces from the shaft to the coupling-contiguous ball bearing in one direction. The entire arrangement is very compact and requires only a few simple and easy to assemble components.

The shaft coupling comprises an alignment gearing that makes a torsion play near zero possible and prevents, or at least greatly reduces, noises and wear and tear which occur with frequent changes in the direction of rotation. As a result of the alignment gearing, a great amount of torque can be transmitted. In addition, during operation the alignment gearing has a self-centering effect on the motor and working shafts coupled to each other.

It is provided that the alignment gearing is centered on the edges with little backlash; as a result, additional centering is unnecessary. The minor amount of backlash reduces the impact load during torque reversal. Moreover, radial forces in the alignment gearing are offset, which reduces the load from radial forces on the bearings of the electric motor and the machine. At the same time, it is advisable if the outer gearing of the alignment gearing is slightly spherical. This facilitates a slight angular compensation between the motor shaft and the working shaft. In the case of smaller torques, the alignment gearing can also be replaced by other connections, for example claw coupling on both sides with rubber cross in between.

A first embodiment of the invention provides that the coupling-contiguous ball bearing is arranged axially, not displaced, with regard to the alignment gearing. To do this, the motor shaft is either provided with internal teeth and the working shaft with external teeth or vice versa to provide the alignment gearing.

In order to achieve good concentricity, centering is provided between the motor shaft and the working shaft, which in the first embodiment is arranged axially displaced with regard to the alignment gearing. It is advisable that the centering is executed as a close, for example polished, fit. This ensures high accuracy.

An outer ring of the coupling-contiguous ball bearing lies axially on a section of the coupling-contiguous end shield. The coupling-contiguous ball bearing can also be held axially free of play between a motor shaft-solid press sleeve and a section of the coupling-contiguous end shield (not shown in the drawings).

A second embodiment of the invention provides that the motor shaft is centered with regard to the working shaft by means of an inner ring of the coupling-contiguous ball bearing. This provides higher accuracy of the centering of the motor shaft with regard to the working shaft. As a result, no additional construction elements (e.g. shaft shoulders) are required to center the motor shaft with regard to the working shaft. In addition, very precise centering is possible, especially because ball bearings are generally formed very precisely.

In the second embodiment, it makes sense that the coupling-contiguous ball bearing is arranged axially displaced with regard to the alignment gearing so that a sufficient gear-tooth length is feasible.

Shock loads can occur during operation. However, to prevent damage to the drive, it is provided that the inner ring of the coupling-contiguous ball bearing forms a clearance fit with the motor shaft. If the spring force is overcome by the shock load, in the case of a clearance fit, the motor shaft can shift in the coupling-contiguous ball bearing, the spring is “pressed flat,” unwinds again after the shock and pushes the motor shaft back into its original position.

Alternatively, it can also be provided that the inner ring of the coupling-contiguous ball bearing forms a press fit with the motor shaft. However, this must then be solid enough to guarantee a secure and stable connection even in the most unfavorable case. In the case of a light press fit, a remaining displacement of the coupling-contiguous ball bearing onto the motor shaft is to be expected because the spring force of a spring washer would not be sufficient to push back the coupling-contiguous ball bearing.

In principle, a diameter centering in the alignment gearing is also conceivable, wherein the tip diameter of the motor shaft interacts with the root diameter of the working shaft or vice versa. This solution, however, is costly to manufacture.

It is also proposed that the outer ring of the coupling-contiguous ball bearing be attached on only one side. Moreover, a clearance fit between the coupling-contiguous ball bearing and motor shaft is provided.

Because the motor shaft in the tooth-gearing section has relatively thin walls and a hollow cylindrical shape, the dimensional stability can be increased by a press sleeve if it is arranged axially, not displaced, with regard to the alignment gearing. In addition, the press sleeve increases the transmissible axial force from the motor shaft to the coupling-contiguous ball bearing.

It has been shown that the non-coupling contiguous bearing of the electric motor can be formed, as usual, as a floating bearing with spring washer.

### DESCRIPTION OF THE SEVERAL VIEWS OF THE DRAWINGS

Exemplary embodiments of the invention are explained in detail below by means of drawings:

FIG. 1 is a schematic diagram of a first embodiment of the invention;

FIG. 2 is a schematic diagram of a second embodiment of the invention;

FIG. 3 is a schematic diagram of a first position of the shafts to one another;

FIG. 4 is a schematic diagram of a second position of the shafts to one another;

FIG. 5 is a schematic diagram of a third position of the shafts to one another;

FIG. 6 is a schematic diagram of the electromotive drive;

FIG. 7 is a schematic diagram of a variant of the first embodiment;

FIG. 8 is a schematic diagram of a variant of the second embodiment; and

FIG. 9 is a schematic diagram of a variant of the electromotive drive.

Reference numbers with apostrophes and corresponding reference numbers without apostrophes indicate items with the same names. These are used in another embodiment and/or the item is a variant. For the sake of simplicity, the list of reference numbers contains only reference numbers without apostrophes.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

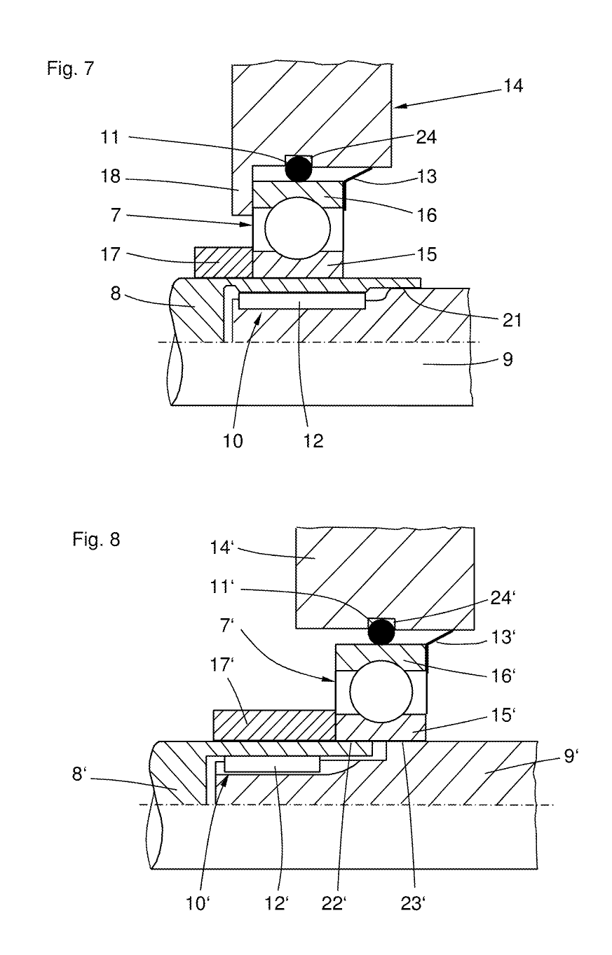

FIGS. 1 and 7 are schematic diagrams of a first embodiment of the invention, having a motor shaft 8, a working shaft 9, a coupling-contiguous end shield 14 with a section 18, a coupling-contiguous ball bearing 7, with an inner ring 15 and an outer ring 16, a press sleeve 17, a clamp disk 13 and a free space 34 that is arranged radially between the outer ring 16 and the coupling-contiguous end shield 14. The motor shaft 8 and the working shaft 9 are connected to each other in a torque-proof manner by a shaft coupling 10 in the form of an alignment gearing 12 centered on the edges. The alignment gearing 12, which consists of mating gear teeth, is arranged axially, not displaced, with regard to the coupling-contiguous ball bearing 7 and to the coupling-contiguous end shield 14. Shown axially displaced with regard to the alignment gearing 12 is a centering section 21 between motor shaft 8 and working shaft 9. The outer ring 16 of the coupling-contiguous ball bearing 7 lies on the motor side of an extended section 18 of the coupling-contiguous end shield 14. The coupling-contiguous ball bearing 7 is held on the machine side by the clamp disk 13, which clamps onto an inner circumference of the coupling-contiguous end shield 14. The press sleeve 17 is pressed firmly onto the motor shaft 8 and forms a limit stop for the inner ring of the coupling-contiguous ball bearing 7.

FIG. 1 shows the free space 34 between the end shield 14 and the outer ring 16 of the coupling-contiguous ball bearing 7 as an empty space, which permits an axial displacement of the coupling-contiguous ball bearing 7 and thus of the motor shaft 8.

FIG. 7 also shows an elastic ring 11 that fits into a groove 24 in the coupling-contiguous end shield 14. The elastic Ring 11 forms a radial flexible connection between the coupling-contiguous ball bearing 7 and the coupling-contiguous end shield 14.

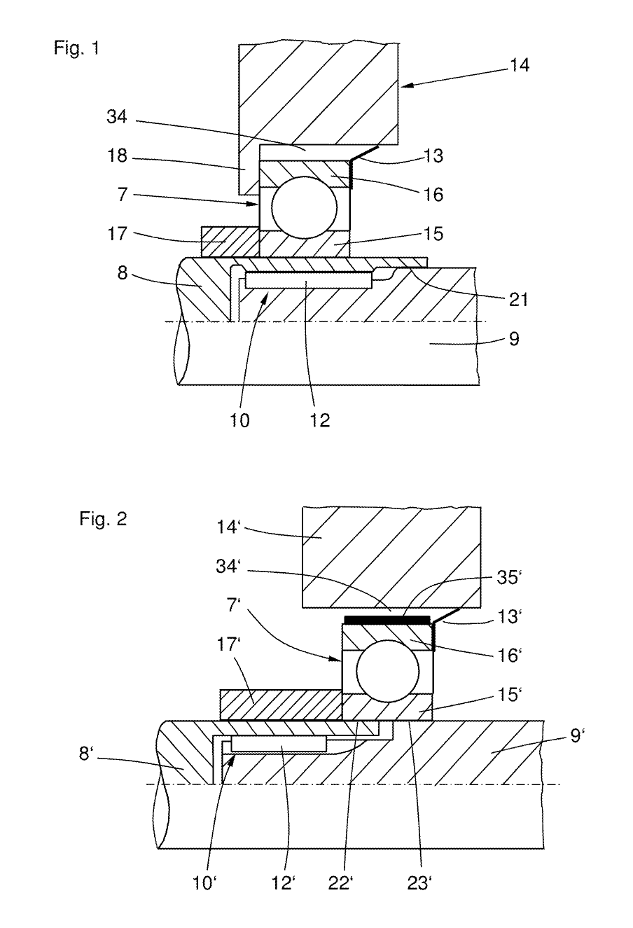

FIGS. 2 and 8 are schematic diagrams of a second embodiment of the invention, having a motor shaft 8′, a working shaft 9′, a coupling-contiguous end shield 14′, a coupling-contiguous ball bearing 7′, with an inner ring 15′ and an outer ring 16′, a press sleeve 17′, a clamp disk 13′ and a free space 34′ that is arranged radially between the outer ring 16′ and the coupling-contiguous end shield 14′. The motor shaft 8′ and the working shaft 9′ are connected to each other in a torque-proof manner by a shaft coupling 10′ in the form of an alignment gearing 12′ centered on the edges. The alignment gearing 12′ is arranged axially displaced with regard to the coupling-contiguous ball bearing 7′ and to the coupling-contiguous end shield 14′. Shown axially displaced with regard to the alignment gearing is a centering section 22′ between the motor shaft 8′ and the inner ring 15′ and a centering section 23′ between the inner ring 15′ and working shaft 9′. The coupling-contiguous ball bearing 7′ is held on the machine side by the clamp disk 13′, which clamps onto an inner circumference of the coupling-contiguous end shield 14. The press sleeve 17′ is pressed firmly onto the motor shaft 8 and forms a limit stop for the inner ring 15′ of the coupling-contiguous ball bearing 7′.

FIG. 2 shows the free space 34′ between the outer ring 16′ of the coupling-contiguous ball bearing 7′ as a partially empty space which permits an axial displacement of the coupling-contiguous ball bearing 7′ and thus of the motor shaft 8′. The coupling-contiguous ball bearing 7′ carries an attenuator 35′ that is not connected to the coupling-contiguous end shield 14′. It could also be a damping agent, such as damping grease. The attenuator 35′ causes a vibration damping of the drive without limiting the freedom of movement of the coupling-contiguous ball bearing 7′ in a radial direction.

FIG. 8 also shows an elastic Ring 11′ that fits into a groove 24′ in the coupling-contiguous end shield 14′. The elastic ring 11′ forms a radial flexible connection between the coupling-contiguous ball bearing 7′ and the coupling-contiguous end shield 14′.

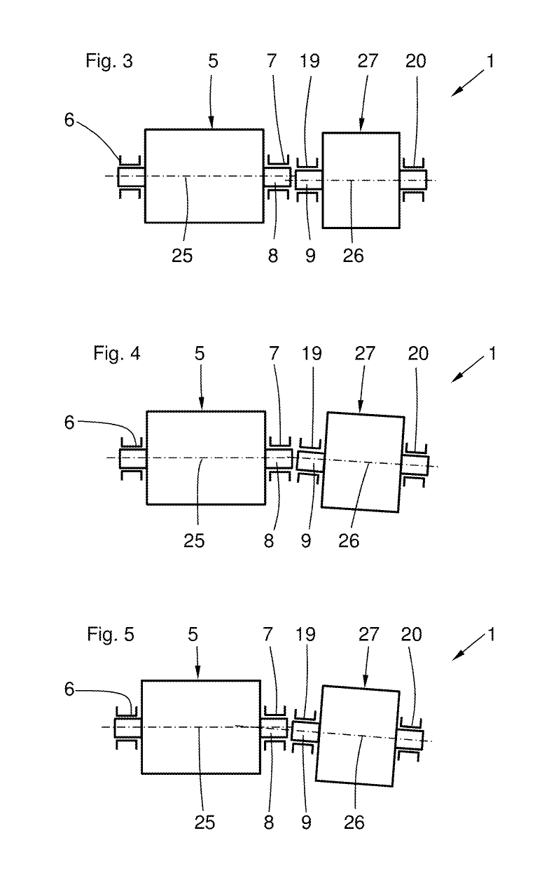

FIGS. 3 through 5 are schematic diagrams of possible positions of a motor shaft 8 with regard to a working shaft 9 of a drive 1, having a motor axis 25, a slave axis 26, a rotor 5 of an electric motor, a working rotor 27, a non-coupling contiguous first bearing 6 and a coupling-contiguous second bearing 7 for the motor shaft 8 and a third bearing 19 and a fourth bearing 20 for the working shaft 9.

FIG. 3 shows a first position, in which the motor shaft 8 is axially displaced vis-à-vis the working shaft 9, but where both shafts run parallel to each other.

FIG. 4 shows a second position, in which the motor shaft 8 is twisted at an angle with respect to the working shaft 9, wherein the motor axis 25 along with the working axis 26 cuts into a coupling area between the two bearings 7 and 19.

FIG. 5 shows a third position, which represents a combination of FIGS. 3 and 4, where there is both an axle misalignment and an angular displacement between the motor shaft 8 and the working shaft 9, wherein normally the axles lie at an angle to one another.

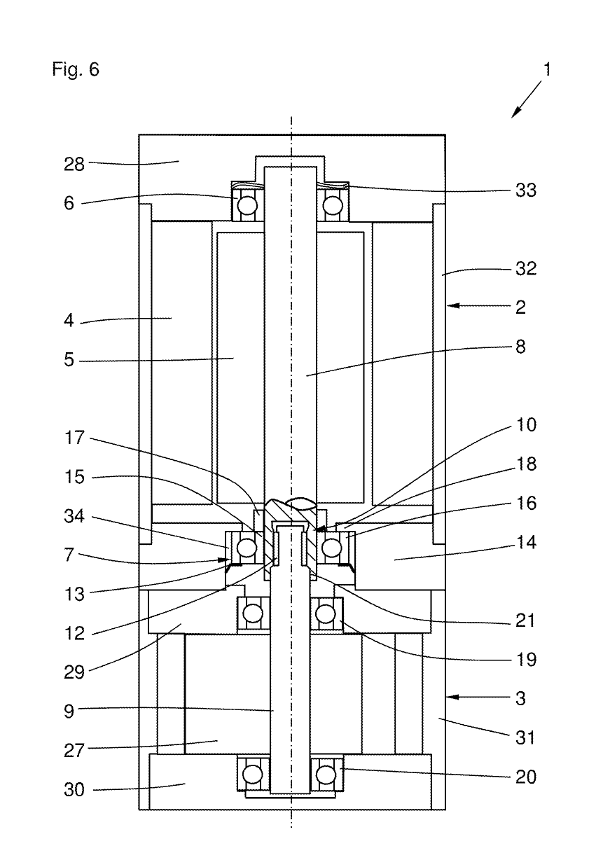

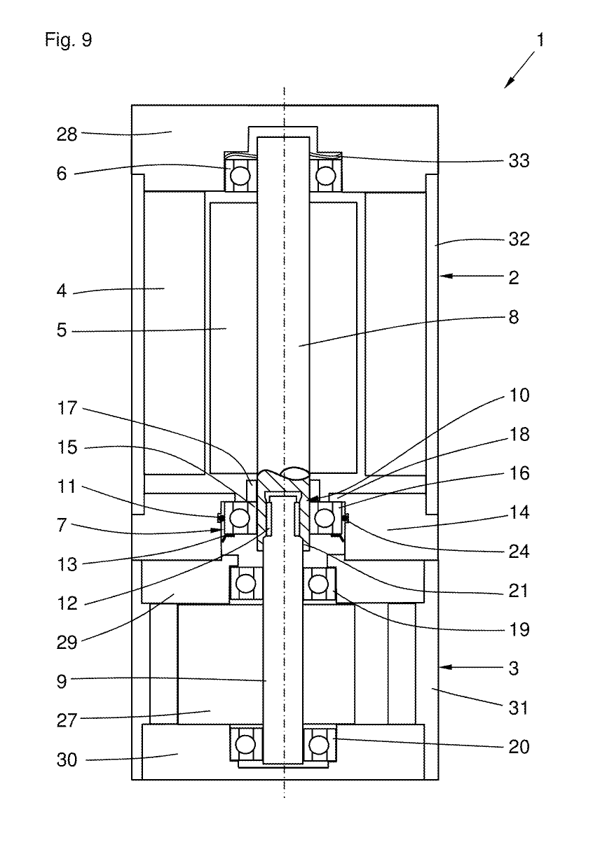

FIGS. 6 and 9 are schematic diagrams of the electromotive drive 1 according to the first embodiment from FIG. 1, having an electric motor 2 and a machine 3 coupled and attached to it. The electric motor has a motor casing 32, a motor casing cover 28, a stator 4, a rotor 5, the motor shaft 8, a non-coupling contiguous bearing 6, the coupling-contiguous ball bearing 7 with the inner ring 15 and the outer ring 16, the press sleeve 17, the free space 34, the clamp disk 13, the coupling-contiguous end shield 14 and the section 18 and a spring washer 33 on the non-coupling contiguous bearing 6. The machine 3 has a work casing 31, a work casing cover 30, a work end shield 29, the working shaft 9, a work rotor 27, a third bearing 19 and a fourth bearing 20. The motor shaft 8 and the working shaft 9 are connected to each other in a torque-proof manner by a shaft coupling 10 in the form of the alignment gearing 12. In the present example, the machine is an oil pump in the form of a gerotor pump. The electric motor is designed as an electronically regulated DC motor.

Also arranged in FIG. 9 in the free space and in a groove 24 in the coupling-contiguous end shield 14 is an elastic ring 11 that forms an elastic connection between the outer ring 16 of the coupling-contiguous ball bearing 7 and the coupling-contiguous end shield 14.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

LIST OF REFERENCE NUMBERS

| | |
|---|---|
| 1 | Drive |
| 2 | Electric motor |
| 3 | Machine |
| 4 | Stator |
| 5 | Rotor |
| 6 | Non-contiguous ball bearing |
| 7 | Contiguous ball bearing |
| 8 | Motor shaft |
| 9 | Working shaft |
| 10 | Shaft coupling |
| 11 | Elastic ring |
| 12 | Alignment gearing |
| 13 | Clamp disk |
| 14 | Coupling-contiguous end shield |
| 15 | Inner ring |
| 16 | Outer ring |
| 17 | Press sleeve |
| 18 | Section |
| 19 | Third bearing |
| 20 | Fourth bearing |
| 21 | Centering |
| 22 | Centering |
| 23 | Centering |
| 24 | Groove |
| 25 | Motor axis of rotation |
| 26 | Working axis of rotation |
| 27 | Work rotor |
| 28 | Motor casing cover |
| 29 | Working end shield |
| 30 | Work casing cover |
| 31 | Work casing |
| 32 | Motor casing |
| 33 | Spring washer |
| 34 | Free space |
| 35 | Attenuator |

What is claimed is:

1. An electromotive drive for use with an electric motor having a rotor with a motor shaft mounted in first and second bearings and a working shaft of a machine, the working shaft being mounted in third and fourth bearings, the electromotive drive comprising:
a shaft coupling for joining the motor shaft to the working shaft to ensure the transmission of torque and radial force from the motor shaft to the working shaft, centering the motor and working shafts relative to one another, not transmitting any axial force and compensating for any misalignment of the motor and working shafts caused by production tolerances;
a coupling-contiguous end shield; and
a coupling-contiguous ball bearing having an outer ring, wherein the motor shaft is mounted axially by means of the coupling-contiguous ball bearing, and the outer ring of the coupling-contiguous ball bearing is not fixed radially to the coupling-contiguous end shield, so that there is no redundancy despite double mounting of the motor shaft to the first and second bearings and the working shaft to the third and fourth bearings.

2. The drive according to claim 1, further comprising a free space located in a radial direction from the coupled shafts between the outer ring of the coupling-contiguous ball bearing and the coupling-contiguous end shield.

3. The drive according to claim 2, wherein the free space between the coupling-contiguous ball bearing and the coupling-contiguous end shield is empty.

4. The drive according to claim 2, wherein an elastic ring is arranged in the free space between the coupling-contiguous ball bearing and the coupling-contiguous end shield.

5. The drive according to claim 2, wherein an attenuator is supported by the outer ring of the coupling-contiguous ball bearing and is arranged radially around the outer ring of the coupling-contiguous ball bearing.

6. The drive according to claim 5, wherein the attenuator does not radially touch the coupling-contiguous end shield or does not affect the position of the coupling-contiguous ball bearing in a radial direction.

7. The drive according to claim 1, further comprising:
a press sleeve mounted on the motor shaft; and
a clamp disk supported on the coupling-continuous end shield, wherein the coupling-contiguous ball bearing is held axially free of play between the press sleeve and the clamp disk.

8. The drive according to claim 1, further comprising alignment gearing having external gearing, the alignment gearing orienting the motor shaft and the working shaft.

9. The drive according to claim 8, wherein the alignment gearing is centered relative to the shaft coupling.

10. The drive according to claim 8, wherein the external gearing of the alignment gearing is slightly spherical.

11. The drive according to claim 8, wherein the coupling-contiguous ball bearing is arranged axially and not displaced with regard to the alignment gearing.

12. The drive according to claim 8, wherein the centering of the motor shaft with the working shaft is arranged axially displaced with regard to the alignment gearing.

13. The drive according to claim 12, wherein the centering is accomplished by means of a close fit.

14. The drive according to claim 1, further comprising a section formed in the coupling-contiguous end shield, wherein the outer ring of the coupling-contiguous ball bearing lies axially against the section of the coupling-contiguous end shield.

15. The drive according to claim 14, further comprising a press sleeve mounted on the motor shaft and a section formed on the coupling-contiguous end shield, wherein the coupling-contiguous ball bearing is held axially free of play between the motor shaft sleeve and the section of the coupling-contiguous end shield.

16. The drive according to claim 1, wherein centering of the motor shaft to the working shaft is accomplished by means of an inner ring of the coupling-contiguous ball bearing, in that the inner ring of the coupling-contiguous ball bearing sits partially on the motor shaft and partially on the working shaft.

17. The drive according to claim 8, wherein the coupling-contiguous ball bearing is arranged axially displaced to the alignment gearing.

18. The drive according to claim 1, wherein the inner ring of the coupling-contiguous ball bearing forms a clearance fit with the motor shaft.

19. The drive according to claim 1, further comprising an inner ring forming part of the coupling-contiguous ball bearing, wherein the inner ring of the coupling-contiguous ball bearing forms a solid press fit with the motor shaft.

20. The drive according to claim 1, wherein the outer ring of the coupling-contiguous ball bearing is axial fixed only on one side.

21. The drive according to claim 7, wherein the press sleeve is arranged axially not displaced with regard to the alignment gearing.
